(19) United States
(12) Patent Application Publication
(10) Pub. No.: US 2013/0022215 A1
(43) Pub. Date: Jan. 24, 2013

(54) METHOD FOR OPERATING A HYBRID VEHICLE

(71) Applicant: Paul Kapus, Judendorf (AT)

(72) Inventor: Paul Kapus, Judendorf (AT)

(73) Assignee: AVL LIST GMBH

(21) Appl. No.: 13/575,510

(22) PCT Filed: Jan. 28, 2011
(86) PCT No.: PCT/EP11/51201

§ 371 Date: Oct. 2, 2012

(30) Foreign Application Priority Data
Jan. 28, 2010 (AT) A 113/2010

(51) Int. Cl. G08B 3/10

(52) U.S. Cl. 381/86; 180/65.245; 903/903

(57) ABSTRACT

The invention relates to a method for operating a hybrid vehicle, in particular a series-produced hybrid vehicle, comprising at least one electric motor and at least one internal combustion engine, wherein the internal combustion engine is operated in at least one first operating range (B, D) of the vehicle, in particular in a stationary manner, and is deactivated in at least one second operating range (A, C) of the vehicle. In order to enable a basic constant sound without sudden changes, a basic sound (S_{B}) which corresponds to the operating sound (S_{C}) of the internal combustion engine is generated during the second operating range (A, C).

The invention relates to a method for operating a hybrid vehicle, especially a series-produced hybrid vehicle, comprising at least one electric motor and at least one internal combustion engine, with the internal combustion engine being operated in at least one first operating range of the vehicle, especially in a stationary manner, and being deactivated in at least one second operating range of the vehicle, and to an apparatus for performing the method.

Electrically operated vehicles emit only a low basic level of sound. This leads to the problem of reduced acoustic perceptibility for other traffic participants, especially pedestrians and cyclists. It is a further disadvantage that the driver will receive only insufficient acoustic feedback on the driving state of the vehicle. In the case of hybrid vehicles with serially activated internal combustion engine there will be an unexpected unforeseeable sound which is independent of the vehicle state when the internal combustion engine is operated in a stationary fashion.

It is known from the publications U.S. Pat. No. 7,501,934 B, WO 08/024361 A1, EP 1 731 372 A1, JP 07-322403 A, JP 06-296400 A, WO 00/12354 A1, EP 753 752 A1 and U.S. Pat. No. 5,635,903 A to play a stored engine sound of an internal combustion engine during the operation of an electric vehicle, with sound generation depending on the type of operation.

It is the object of the invention to enable constant emission of sound by avoiding sudden changes in sound in a hybrid vehicle with a discontinuously operated internal combustion engine.

This is achieved in accordance with the invention in such a way that a basic sound is artificially generated during the second operating range which corresponds to the operating sound of the internal combustion engine.

It is preferably provided that the basic sound is switched off during the first operating range. The basic sound is advantageously generated in a digital manner.

In order to prevent a homogeneous sound emission without any sudden changes, it is advantageous if the basic sound is dynamically applied to the operating sound of the internal combustion engine in an inverse manner at least in part.

It can be provided in a further development of the invention that an artificial, preferably digitally generated, driving sound is superimposed on the artificially generated basic sound and the operating sound of the internal combustion engine, with a driving sound being generated depending on the driving speed and/or the speed of the electric motor and/or the position of the accelerator pedal and/or the load torque. Since the basic sound is superimposed with a driving sound depending on the driving situation, the driver is provided with feedback on the loading and speed state, as in conventional vehicles that are driven with internal combustion engines. The basic sound and/or driving sound can be emitted to the inside or outside of the passenger compartment of the vehicle.

When the internal combustion engine is deactivated, the stored basic sound of the internal combustion engine will be generated via a sound generation device via one or several loudspeakers which can be arranged outside of the vehicle and/or in the interior space of the vehicle, with the loudness being variable depending on at least one operating parameter. For example, a low loudness can be activated when the activation of the internal combustion engine will still occur far in the future. On the other hand, the original loudness can be raised when the activation of the internal combustion engine will occur in the near future. Since the internal combustion engine will generally be activated when falling beneath a defined minimum charging state of the rechargeable battery, the battery charging state can be used as a parameter for the loudness.

When the internal combustion engine starts up, the sound generation device will be deactivated and replaced by the real operating sound of the internal combustion engine. Conversely, the sound generation device will be activated upon deactivation of the internal combustion engine, optionally with respective adaptation of the loudness. This leads to a constant basic sound of the vehicle in which the activation and deactivation of the internal combustion engine will remain acoustically non-perceivable.

The digitally generated sound can partly also be used to cancel out parts of the operating sound of the internal combustion engine (active noise cancellation). In order to achieve this, it is provided that during the first operating range the basic sound is emitted in a phase-inverted manner in relation to the operating sound of the internal combustion engine.

The invention will be explained below in closer detail by reference to the drawings, wherein:

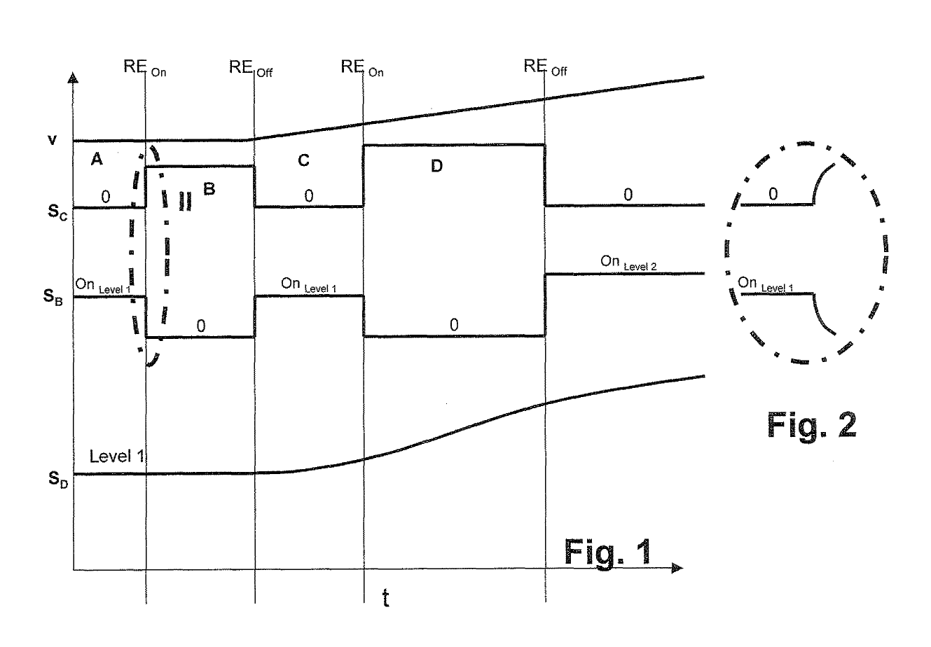

FIG. 1 shows an operating diagram of the hybrid vehicle; and

FIG. 2 shows the detail II of FIG. 1.

FIG. 1 shows a diagram in which the driving speed v, operating sound S_{C} of the internal combustion engine, the artificially generated basic sound S_{B} and the artificially generated driving sound S_{D} are shown over time t for an embodiment. The activation points of the internal combustion engine are designated with RE_{On}, and the deactivation points with RE_{Off}.

The internal combustion engine is activated in the first operating ranges B, D of the vehicle and generates an operating sound S_{C} which corresponds to the loading state, with the operating sound S_{C} being higher in the operating range D than in the operating range B. The internal combustion engine is deactivated in the second operating ranges A and C, and therefore does not generate any sound. An artificial sound S_{B} is generated in the operating ranges by the sound generation device, which artificial sound corresponds in respect of its quality and level approximately to the operating sound S_{C}. This leads to a constant operating sound of the vehicle in which the activation and deactivation of the internal combustion engine remains acoustically non-perceivable.

If the internal combustion engine comprises several operating points with different sound levels, as is shown in FIG. 1 in the operating ranges B and D, the artificial basic sound S_{B} can also be adjusted to the different level of the operating sound S_{C} of the internal combustion engine, as indicated by the levels of the basic sound On_{Level1} and On_{Level2}.

In order to provide the driver with a smooth sound emission, the basic sound S_{B} can be applied to the operating sound S_{C} of the internal combustion engine in an inverse fashion, which is shown in FIG. 2. Peaks or graduations in the sound emission are prevented thereby.

In order to provide acoustic feedback on the driving state, the basic sound S_{B} can be superimposed by an artificially generated driving sound S_{D}, wherein the driving situation can be characterised by the driving speed v and/or the speed of the electric motor, the position of the accelerator pedal, the torque or the like. The driver is thereby provided with acoustic feedback on the current driving state, as in conventional vehicles operated by means of internal combustion engines.

1-13. (canceled)

14. A method for operating a hybrid vehicle, comprising at least one electric motor and at least one internal combustion engine, with the internal combustion engine being operated in at least one first operating range of the vehicle and being deactivated in at least one second operating range of the vehicle, wherein a basic sound is artificially generated during the second operating range, which basic sound corresponds to an operating sound of the internal combustion engine.

15. The method according to claim 14, wherein the basic sound will be switched off during the first operating range.

16. The method according to claim 14, wherein the basic sound is generated digitally.

17. The method according to claim 14, wherein the basic sound will dynamically be applied at least in part in an inverse manner to the operating sound of the internal combustion engine.

18. The method according to claim 14, wherein the basic sound or the driving sound is changed depending on at least one parameter.

19. The method according to claim 18, wherein said at least one parameter is a charging state of an electric storage unit.

20. The method according to claim 14, wherein an artificial driving sound is superimposed on the artificially generated basic sound and the operating sound of the internal combustion engine, with the driving sound being generated depending on at least one of the group driving speed, speed of the electrical machine, accelerator pedal position or load torque.

21. The method according to claim 20, wherein the driving sound is digitally produced.

22. The method according to claim 14, wherein the basic sound is emitted into an interior space of the vehicle.

23. The method according to claim 14, wherein the driving sound is emitted into the interior space of the vehicle.

24. The method according to claim 14, wherein the basic sound is emitted to an outside of the vehicle.

25. The method according to claim 14, wherein the driving sound is emitted to the outside of the vehicle.

26. The method according to claim 14, wherein the basic sound is emitted in a phase-inverse manner in relation to the operating sound of the internal combustion engine during the first operating range.

27. The method according to claim 14, wherein the internal combustion engine is operated in a stationary manner.

28. An apparatus for performing a method for operating a hybrid vehicle, comprising at least one electric motor and at least one internal combustion engine which can be operated in at least one first operating range of the vehicle and which can be deactivated in at least one second operating range of the vehicle, wherein the apparatus comprises a sound emission device, a synthetic sound generation device and a control device, with the control device having an input for at least one operating parameter of the internal combustion engine, and with the sound generation device being activatable and deactivatable by the control device depending on the operating parameter.

29. The apparatus according to claim 28, wherein the control device comprises an input for at least one operating parameter of the vehicle, with the sound generation device being triggerable by the control device depending on the operating parameter of the vehicle.

30. The apparatus according to claim 28, wherein the sound generation device opens into one interior space of the vehicle.

31. The apparatus according to claim 28, wherein the sound generation device is arranged outside of the vehicle.

32. The apparatus according to claim 28, wherein the vehicle is a series-produced hybrid vehicle.
